(19) United States
(12) Patent Application Publication
(10) Pub. No.: US 2026/0051232 A1
(43) Pub. Date: Feb. 19, 2026

(54) System

(71) Applicant: SoftBank Group Corp., Tokyo (JP)

(72) Inventor: Hiroaki Mioki, Tokyo (JP)

(21) Appl. No.: 19/299,558

(22) Filed: Aug. 14, 2025

(30) Foreign Application Priority Data
Aug. 19, 2024 (JP) 2024-137958

(51) Int. Cl. G08B 7/06; G01W 1/10; G05D 1/60; G05D 101/10; G05D 105/55; G05D 105/80; G05D 109/10; G05D 109/20; G06F 40/58; G08B 21/10

(52) U.S. Cl. CPC G08B 7/066; G01W 1/10; G05D 1/60; G06F 40/58; G08B 21/10; G05D 2101/10; G05D 2105/55; G05D 2105/80; G05D 2109/10; G05D 2109/20

(57) ABSTRACT

A system includes a processor that collects and analyzes meteorological data and sensor data in real time, predicts future disaster risks based on past disaster data, detects abnormal patterns and identifies precursors of disasters, automatically issues warnings based on identified precursors, calculates optimal evacuation routes and provides them to users in real time, and supports information exchange between affected areas and relief teams.

### CROSS-REFERENCE TO RELATED APPLICATION

This application is based on and claims priority under 35 USC 119 from Japanese Patent Application No. 2024-137958 filed on Aug. 19, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, natural disasters such as floods, earthquakes, and typhoons have caused significant loss of life and property worldwide. Existing disaster management systems are often limited in their ability to provide real-time situational awareness, early warnings, optimal evacuation guidance, efficient allocation of relief resources, and effective communication between disaster-affected regions and relief teams, especially across language barriers. Furthermore, there remains a need for an integrated solution capable of leveraging artificial intelligence, real-time data collection, and advanced robotics to respond to rapidly evolving disaster scenarios and support decision making for authorities and the public.

### SUMMARY

To address these problems, the present invention provides a system including a processor that collects and analyzes meteorological and sensor data in real time, predicts future disaster risks based on past disaster data, detects abnormal patterns as disaster precursors, and issues automatic warnings based on these precursors. The processor further calculates optimal evacuation routes and provides them to users in real time, and supports information exchange between affected areas and relief teams. Additionally, the processor controls AI-equipped drones and robots to collect and analyze information from disaster sites in real time, predicts the extent of damage and required resources based on analyzed data, and plans the distribution of relief supplies and medical resources. Furthermore, the processor performs natural language processing and translation between different languages to enhance communication between affected regions and relief teams, thereby enabling a comprehensive and effective disaster response.

“Meteorological data” means information relating to atmospheric conditions such as temperature, humidity, rainfall, wind speed, pressure, and weather patterns obtained from weather stations, satellites, and other sources.

“Sensor data” means information collected from electronic sensors including but not limited to seismic sensors, river water level gauges, and environmental monitors, which measure physical parameters relevant to disaster detection and management.

“Real time” means the processing, collection, analysis, or communication of data is conducted immediately or with minimal delay, allowing for prompt responses to changing conditions.

“Past disaster data” means historical records and documented information regarding previous occurrences of natural or man-made disasters, including causes, effects, and response actions.

“Abnormal patterns” means data trends or values detected by the system which significantly deviate from normal or safe ranges, indicating potential risk or the onset of a disaster.

“Precursors of disasters” means early detectable signs, patterns, or phenomena identified from data, which are indicative of the possible occurrence of a disaster.

“Warnings” means automatic notifications, alerts, or advisories issued by the system to inform users or authorities of imminent or potential disasters.

“Evacuation routes” means recommended paths or directions determined by the system to guide users safely from hazardous or affected areas to predetermined safe locations.

“Users” means individuals or entities who interact with or receive services from the system, including residents, first responders, and officials in disaster-affected areas.

“Information exchange” means the communication and transfer of relevant data, reports, or instructions between affected regions, users, and relief teams.

“Relief teams” means organized groups or agencies responsible for providing emergency response, rescue operations, medical support, and the distribution of relief supplies during or after a disaster.

“AI-equipped drones and robots” means unmanned aerial vehicles or robotic devices integrated with artificial intelligence capabilities for autonomous or semi-autonomous data collection, analysis, and operational tasks during disaster management.

“Damage and risk prediction” means the estimation of the likely extent and severity of harm or threat based on current and historical data processing by the system.

“Relief supplies and medical resources” means essential items such as food, water, shelter material, medicines, and medical equipment intended for distribution to affected populations during disaster response.

“Natural language processing and translation” means computational techniques applied by the system to analyze, interpret, and convert communication between different human languages to facilitate mutual understanding.

“Communication enhancement” means improvements in the exchange and clarity of information among users, affected regions, and relief teams, especially through multilingual processing and advanced system features.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1:

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

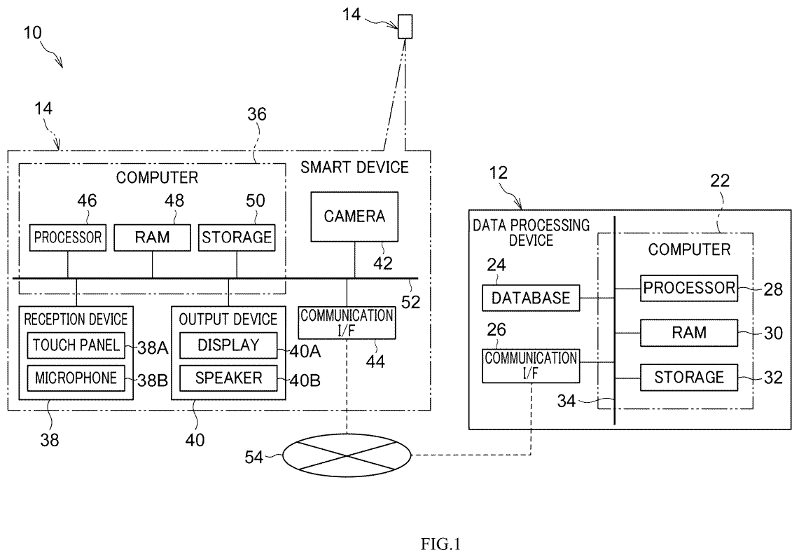

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

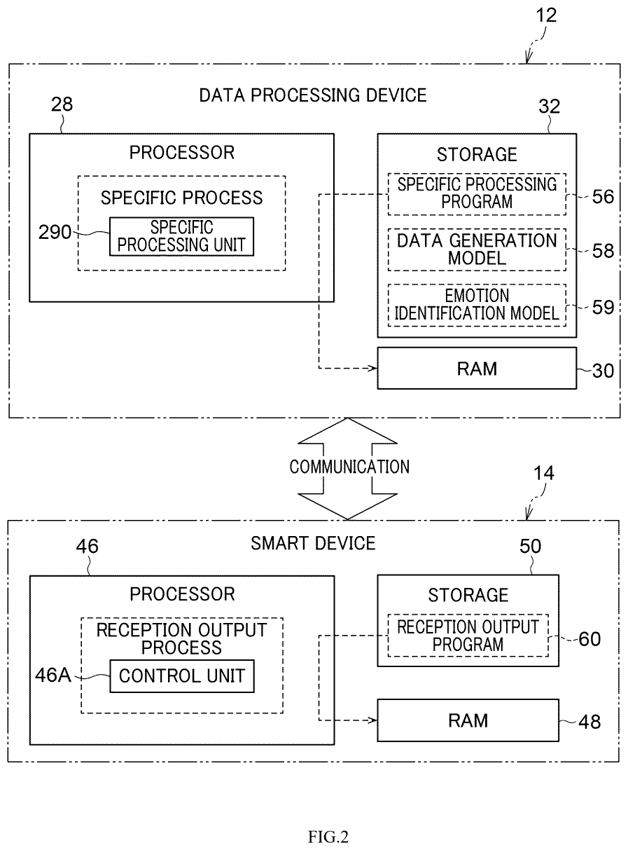

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, the occurrence and severity of natural disasters have increased, creating significant challenges in rapidly predicting disaster risks, issuing timely warnings, optimizing evacuation routes, and ensuring efficient communication among affected individuals and relief organizations. Conventional disaster management systems often lack the ability to collect and analyze heterogeneous data sources in real time, accurately detect abnormal patterns or disaster precursors, and provide user-customized, up-to-date guidance and resource allocation. Furthermore, there is a lack of seamless multilingual communication support and the effective use of autonomous vehicles or robots for on-site intelligence gathering, which limits the speed and effectiveness of rescue operations.

The specific processing by the specific processing unit 290 of the data processing device 12 in Example 1 is realized by the following means.

The present invention provides a server including a processor configured to collect and standardize environmental and situational data in real time, analyze the data using a machine learning model to detect abnormal trends or disaster precursors, utilize a generative artificial intelligence model with prompt sentences to analyze historical disaster data and predict future risk, immediately issue alerts to user devices upon recognition of hazards, calculate optimal evacuation routes by considering current situational and traffic data, coordinate information exchange and support requests among relief organizations, control autonomous vehicles for real-time site intelligence gathering, estimate affected areas and resource needs, and support multilingual communication between affected individuals and relief teams. This enables rapid and accurate disaster risk detection, efficient evacuation guidance, optimized resource allocation, and seamless communication in disaster response operations.

The term “environmental data” refers to sensor readings and measurements related to physical conditions of a specific area, such as temperature, humidity, wind speed, precipitation, seismic activity, and water levels, collected in real time or at regular intervals.

The term “status data” refers to contextual or situational information, including but not limited to human activity data, infrastructure status, road closure information, population movement, and user-reported events, relevant to disaster assessment and response.

The term “observation devices” refers to hardware components, including but not limited to meteorological sensors, geophysical sensors, imaging devices, and mobile devices, that acquire environmental data and status data for processing.

The term “processor” refers to a computational unit, such as a central processing unit (CPU), microcontroller, or cloud-based computing resource, configured to execute programmed instructions associated with the disaster response system.

The term “machine learning model” refers to a form of artificial intelligence employing statistical and computational methods to detect patterns, make predictions, and classify data based on training from historical datasets.

The term “generative artificial intelligence model” refers to an automated algorithm capable of generating analytic results, predictions, or translations, using prompt sentences and historical data, including but not limited to large language models.

The term “prompt sentence” refers to a user-generated or system-generated instruction or query formulated in natural language, designed to guide the operation of a generative artificial intelligence model for risk analysis or other tasks.

The term “user device” refers to an information processing terminal, such as a smartphone, tablet, or personal computer, used for receiving alerts, submitting data, navigating evacuation routes, or exchanging information.

The term “route generation unit” refers to a software or hardware module responsible for computing and recommending optimal evacuation or movement paths based on real-time environmental, traffic, and geographic conditions.

The term “communication unit” refers to a hardware or software interface that enables data exchange between the server, user devices, and external systems via wired or wireless communication networks.

The term “autonomous mobile body” refers to a remotely operated or self-navigating robotic platform, including but not limited to unmanned aerial vehicles and ground robots, equipped with sensors and intelligence-gathering capabilities.

The term “relief organization” refers to an entity, group, or institution engaged in providing emergency support, rescue operations, resource allocation, and relief services during or after disasters.

The term “allocation plan” refers to a calculated distribution schedule for essential goods and resources, such as life support supplies and medical items, determined based on disaster impact assessment and resource requirements.

The term “multilingual communication” refers to the ability of the system to interpret, translate, and relay textual or spoken messages in multiple languages to facilitate clear communication between users and relief organizations.

The term “alert information” refers to notification content generated by the system and transmitted to user devices to inform them of detected hazards, abnormal events, or recommended actions in the event of a disaster.

One embodiment of the invention provides a comprehensive disaster response system that enables real-time risk detection, warning notification, optimal evacuation guidance, resource allocation, and multilingual communication between affected individuals and relief organizations. The system comprises a server equipped with a processor, an information storage unit, a communication interface, and, as necessary, a control interface for autonomous mobile bodies, as well as a plurality of user devices including smartphones, computers, or tablets.

The server acquires environmental data such as temperature, humidity, seismic data, and water level readings from observation devices including meteorological sensors, seismographs, and IoT-based data sources. The acquisition is performed at predetermined intervals or in response to specific events via communication interfaces, utilizing hardware such as general-purpose servers or cloud-based virtual machines. For example, the server can use Python scripts to fetch weather data through public APIs and IoT messaging protocols, storing the data in relational databases such as PostgreSQL.

The server standardizes and cleans the acquired data using data preprocessing methods implemented in software (such as Python and data science libraries) to ensure uniformity and accuracy. The server then analyzes the collected environmental and status data using a machine learning model (for instance, implemented with TensorFlow) to detect abnormal trends indicating possible disaster precursors. When detection occurs, the server generates and sends alert information to all relevant user devices using communication protocols including push notifications or messaging services such as generic cloud messaging APIs.

To predict future disaster risk, the server utilizes a generative AI model (such as a general-purpose large language model) by submitting structured prompt sentences together with past disaster data. The server formulates prompt sentences such as:
“Based on historical hurricane data, analyze current weather data and forecast future hurricane risk.”
“Provide sample code for an algorithm that analyzes collected sensor and meteorological data to detect flood risks early.”
“Show a method to translate disaster status entered in Japanese into English and notify the relief team.”

The generative AI model returns a risk estimation, which the server processes and stores, allowing advance warning and preparations to be made.

When a disaster event is ongoing or imminent, the user terminal (e.g., smartphone) obtains its geographical location information via GPS and sends it to the server. The server leverages route generation software components (with access to third-party APIs for map and traffic data) to compute the optimal evacuation route, taking into consideration real-time traffic, blocked roads, and hazards. The server transmits route instructions to the terminal. The terminal displays the recommended evacuation path and provides navigation cues for the user.

If deeper situational awareness is required, the server is configured to control autonomous mobile bodies such as drones or ground robots, issuing remote operation commands to perform surveillance or collect additional environmental and visual data at the disaster site. The acquired data is returned to the server to support decision making.

The server further processes the integrated data to estimate impacted regions, as well as the prospective demand for essential resources such as food, water, shelter, and medical supplies. Using historical and real-time data, the server automatically generates allocation plans and notifies relief organizations for timely and accurate response.

For communication enhancement, when the user inputs information or a support request on the terminal in a natural language (either text or voice), the terminal transmits the input to the server. The server employs the generative AI model to perform natural language understanding and translation, enabling the content to be promptly and accurately relayed to relief teams regardless of language barriers. For example, if a user inputs a message in Japanese, the server translates and delivers the corresponding message in English to the responsible organization.

In this way, by integrating hardware such as sensors, data processing servers, user terminals, communication links, and optionally autonomous vehicles, with software platforms including operating systems (such as generic Linux), relational databases (such as PostgreSQL), machine learning frameworks (such as TensorFlow), large language models, and mapping or messaging APIs, the invention enables an end-to-end, automated and intelligent disaster response workflow.

This embodiment ensures rapid and accurate detection of disaster risks, early alert notification to users, dynamic evacuation guidance based on real-time conditions, optimized allocation of relief resources, and effective, multilingual communication between all parties involved in disaster response.

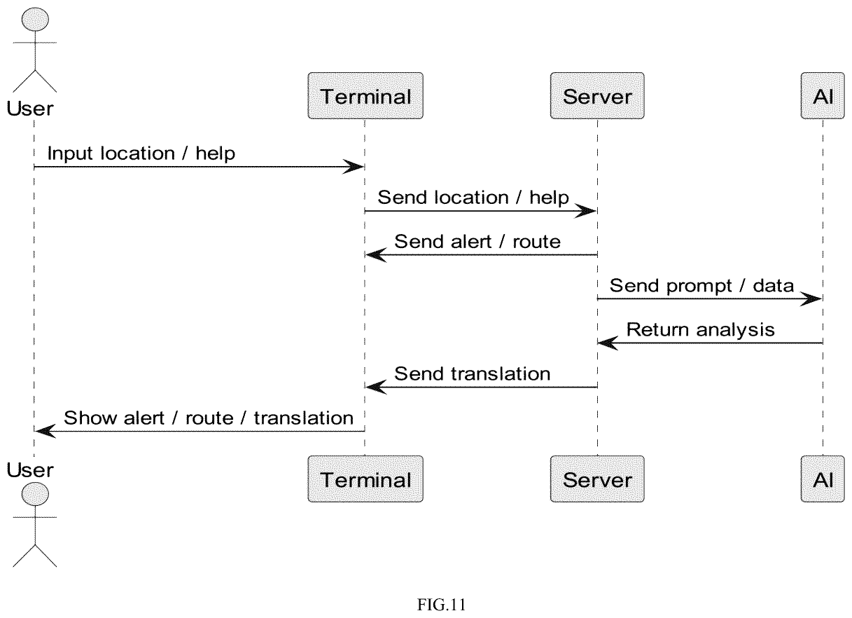

The following describes the processing flow using FIG. 11.

### Step 1:

Server collects environmental data such as temperature, humidity, wind speed, seismic activity, and water levels from observation devices (e.g., weather sensors, seismographs, and IoT devices) at regular intervals using API requests and messaging protocols. The input is raw time-series data obtained from each observation device. Server processes and standardizes the data by checking for missing values, normalizing units, and formatting timestamps. The output is a structured and clean dataset stored in a database.

### Step 2:

Server analyzes the standardized environmental and status data using a machine learning model, such as a neural network implemented in a data analysis framework. The input is the clean dataset from the previous step. Server performs data analysis to detect abnormal patterns, such as sudden increases in river levels or unusual seismic activity, which may indicate potential disaster precursors. The output is a list of detected abnormalities, with associated metadata, stored in an alerts table.

### Step 3:

Server generates alert information based on the abnormalities detected by the machine learning model. The input is the list of abnormalities and their metadata. Server creates actionable alert messages containing details such as the type of threat, affected area, and recommended actions. The output is an alert package ready for distribution.

### Step 4:

Server immediately notifies user devices of any relevant alert information through push notifications, SMS, or dedicated applications. The input is the alert package from the previous step. Server selects the appropriate user devices based on user location and other criteria, and transmits the alert. The output is the reception of alert notifications on user devices.

### Step 5:

Server predicts future disaster risks by interacting with a generative AI model. The input consists of past disaster-related data and prompt sentences formulated for risk analysis, such as “Based on historical hurricane data, analyze current weather data and forecast future hurricane risk.” Server submits these to the generative AI model and receives analytic results, which may include risk probabilities and recommended actions. The output is a set of risk predictions stored in a risk database and made available for display to organizations or users.

### Step 6:

User device (terminal) acquires the user's current geographic location using built-in GPS functionality. The input is a request (explicit or implicit) to determine position, resulting in latitude/longitude data as output. User device sends this location information to the server.

### Step 7:

Server calculates an optimal evacuation route for each user based on current location, traffic conditions, map data, and hazards. The input is the user's location, real-time traffic and hazard data, and digital map information. Server applies a routing algorithm, possibly invoking external map or traffic APIs, to determine a safe and efficient evacuation route. The output is a detailed route map and navigation instructions.

### Step 8:

User device receives the evacuation route from the server and displays it on a map interface, providing step-by-step navigation to the user. The input is the route information from the server. User device processes the data to display a visual map and may provide real-time navigation assistance. The output is a dynamic map with navigation cues on the user device.

### Step 9:

If a user needs to request assistance, user inputs a help or situation message in natural language via text or voice into the user device. The input is the user's natural language message. User device transmits the message to the server for further processing.

### Step 10:

Server utilizes a generative AI model to interpret and, if necessary, translate user-reported information into the required language for relief organizations. The input is the user's message, as well as a prompt sentence guiding the translation or extraction task. Server processes the input with the generative AI model and generates a translated or summarized report. The output is an actionable message or support request delivered to the relevant relief team.

### Step 11:

Server, if equipped and necessary, sends operation commands to autonomous vehicles (e.g., drones or mobile robots) for on-site investigation or data collection. The input is the need for additional on-site intelligence, such as current imagery or environmental measurements. Server transmits mission instructions to the autonomous vehicle, receives live data, and processes it through the system. The output is fresh site-specific data and analysis relayed to decision-makers or rescue crews.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In recent years, the frequency and severity of natural disasters have increased, necessitating rapid and accurate disaster response to minimize loss of life and property. Existing disaster management systems face several challenges, including insufficient real-time collection and analysis of meteorological and sensor data, delays in predicting disaster risks based on historical data, a lack of early abnormal pattern detection, ineffective warning notifications, suboptimal evacuation route guidance, communication barriers between affected regions and rescue teams, and inadequate adaptive responses tailored to user emotion and intent. Furthermore, the lack of efficient integration of autonomous devices for real-time situational awareness and optimal allocation of rescue resources further impedes rapid and effective disaster management.

The specific processing by the specific processing unit 290 of the data processing device 12 in Application Example 1 is realized by the following means.

The present invention provides a server including a processor configured to acquire and analyze real-time time-series data from measurement devices, predict disaster risks using historical records, detect abnormal fluctuations and disaster precursors using machine learning, automatically generate and deliver alert notifications, calculate and dynamically present optimal evacuation routes, perform multilingual analysis and translation of user input for communication with organizations, estimate user emotional states for adaptive guidance, generate responses using a generative artificial intelligence model, control autonomous mobile bodies for situational analysis, and plan optimal allocation of resources for disaster response. This enables rapid, accurate, and adaptive disaster prediction, notification, evacuation support, multilingual communication, psychological consideration, real-time on-site assessment, and efficient resource management, thereby greatly improving safety and effectiveness in disaster situations.

The term “processor” refers to an information processing unit capable of performing various computational and logical operations required to execute the functions of the system.

The term “measurement device” refers to a generic sensing module including but not limited to sensors such as weather observation equipment, seismic sensors, water level meters, temperature sensors, and related devices capable of collecting environmental data.

The term “time-series data” refers to sequential data points collected or recorded at successive points in time, typically representing dynamic environmental or sensor information.

The term “storage unit” refers to a data storage component or system, such as a database or memory device, used to permanently or temporarily retain collected data.

The term “analysis unit” refers to a software or hardware module configured to process, analyze, and extract meaningful information from collected data, including anomaly detection and disaster prediction.

The term “historical record data” refers to archived or previously collected data pertaining to environmental conditions, disaster occurrences, and related historical events.

The term “future event prediction” refers to the estimation of the likelihood or risk of future disasters based on the analysis of historical and real-time data.

The term “machine learning unit” refers to a computational module that employs algorithms and models capable of learning from data to recognize patterns, detect anomalies, and make predictions without explicit programming.

The term “anomaly detection” refers to the identification of deviations or abnormal patterns in observed data that may indicate the onset of a disaster or hazardous event.

The term “disaster precursor” refers to an abnormal pattern, trend, or indicator recognized in advance signaling the potential occurrence of a disaster.

The term “warning information” refers to an alert or notification message generated automatically in response to detected risks or precursors, intended to inform users and relevant parties of potential danger.

The term “portable information terminal” refers to a transportable user device such as a smartphone, tablet, or notebook computer capable of receiving, displaying, and transmitting information.

The term “positioning device” refers to any hardware or software module, such as a GPS unit, that determines and provides the geographic location of a user or object.

The term “route network information” refers to data describing roads, pathways, and traffic conditions used to compute optimal evacuation or travel routes.

The term “audio processing unit” refers to a module capable of analyzing, converting, or interpreting speech or audio input received from a user.

The term “natural language processing unit” refers to a computational module that processes, analyzes, and understands human language text or speech input.

The term “multilingual conversion unit” refers to a translation module, either software or hardware-based, that transforms input data from one language into one or more other target languages.

The term “external communication network” refers to any public or private communication system, such as the internet or telecommunications network, used for information exchange with remote parties.

The term “emotion evaluation unit” refers to a computational component that estimates the emotional state of a user based on input data such as voice, text, or biometric indicators.

The term “generative artificial intelligence model” refers to an AI system capable of producing or generating text, instructions, or other forms of output in response to input prompts, typically utilizing advanced machine learning architectures.

The term “autonomous mobile body” refers to a self-propelled device, such as a robot or unmanned aerial vehicle, capable of performing tasks and gathering information without human intervention.

The term “observation device” refers to a generalized sensing instrument, including but not limited to cameras, environmental sensors, or other devices for monitoring surroundings.

The term “resource allocation planning unit” refers to a module designed to create plans for distributing assets, materials, or personnel efficiently in response to disaster conditions.

The term “affected area prediction unit” refers to a system component that analyzes data to estimate the geographic region likely to be impacted by a disaster event.

One embodiment for implementing the invention will be described below. The present invention may be realized as a disaster response system including a server, a plurality of terminals, a group of measurement devices, and communication means interconnecting these components.

The server includes a processor, memory, and storage. The processor is configured to execute software programs responsible for real-time data acquisition, analysis, anomaly detection, disaster prediction, notification delivery, route calculation, communication processing, emotion estimation, and generative response. The memory and storage are used to retain historical data, sensor readings, user profiles, and operational parameters.

Measurement devices may include but are not limited to environmental sensors such as weather stations, seismic sensors, water level meters, temperature sensors, and positioning hardware such as GPS modules. These measurement devices provide time-series data through wired or wireless networks (such as Wi-Fi, LTE, 5G, or specialized IoT networks) to the server.

Each terminal may be a portable information device, such as a smartphone, tablet, or PC, equipped with a display, microphone, processor, and communication interface. The terminal collects user input, including audio or text messages, current location data, and emergency requests. Terminals use GPS to determine the user's position and transmit this data to the server via network communication.

The server obtains meteorological data and environmental data in real time from measurement devices and stores it in a high-speed database, such as a relational database management system (for example, PostgreSQL or MySQL) or a NoSQL system (such as MongoDB). The server periodically cleans and preprocesses the incoming data using data management software.

The server employs analysis software based on machine learning libraries or frameworks, such as TensorFlow or PyTorch, to analyze real-time and historical data. The analysis software is configured to perform anomaly detection, disaster precursor identification, and future risk prediction by utilizing trained models. The processor computes risk estimates and identifies abnormal fluctuation patterns—such as sudden changes in sensor readings, rapid increases in water level, or accelerated seismic activity.

If the server determines the presence of a disaster precursor or elevated risk, the processor automatically generates warning information tailored to the context. The server delivers this information in the form of push notification messages, which may be distributed using cloud messaging services (such as Firebase Cloud Messaging or equivalent generic notification systems), and ensures that information reaches portable information terminals in a timely manner. Alerts may be visually and audibly presented on the terminal through its user interface.

When a user needs evacuation guidance, the terminal sends current location data to the server. The server calculates the optimal evacuation route by integrating real-time road network data, traffic obstruction information, and live hazard maps. The server utilizes route calculation algorithms and, optionally, map and traffic data APIs to generate an individualized evacuation path. The route information is transmitted to the terminal, which displays the path in a map view and provides updates as conditions change.

For multilingual communication and prompt message processing, the terminal captures user input as speech or text. The terminal may use onboard software for speech-to-text processing, or send data to the server, where audio and text are processed using generic natural language processing modules and converted between languages using a translation engine (for instance, a cloud translation API). The content, once translated, is shared securely with relevant organizations, such as emergency responders or international rescue teams.

The terminal and server together implement an emotion estimation engine: the terminal analyzes audio or text information to estimate the user's emotional state (such as stress, panic, or calm) and transmits emotion data to the server. The server tailors notifications and recommendations according to detected emotional state, and, if necessary, escalates the response by notifying medical staff or counselors.

Generative AI (such as a large language model inference engine, running locally or in the cloud) may be used to generate responses to user queries, explain disaster risks, or create adaptive evacuation instructions outlined in understandable language, based on input prompts.

For example, when a user sends the following prompt:

“Is the flood risk increasing at my location? Show me the safest evacuation route, and send an English-language rescue request.”

The server processes live sensor and historical data, performs real-time risk and route assessment, translates rescue requests for external agencies, and generates an integrated response for the user.

The system may additionally interface with autonomous mobile bodies such as unmanned aerial vehicles or ground robots, which are remotely controlled by the server, equipped with cameras and sensors for real-time data collection at disaster sites. The results of on-site analysis, conducted by the server using computer vision and sensor fusion techniques, are fed back into the system to enhance decision-making and optimize the allocation of rescue or relief resources.

Through this embodiment, robust disaster detection, adaptive communication, proactive resource planning, psychological support, and comprehensive user guidance can be realized, providing significantly improved safety and response capabilities in disaster scenarios.

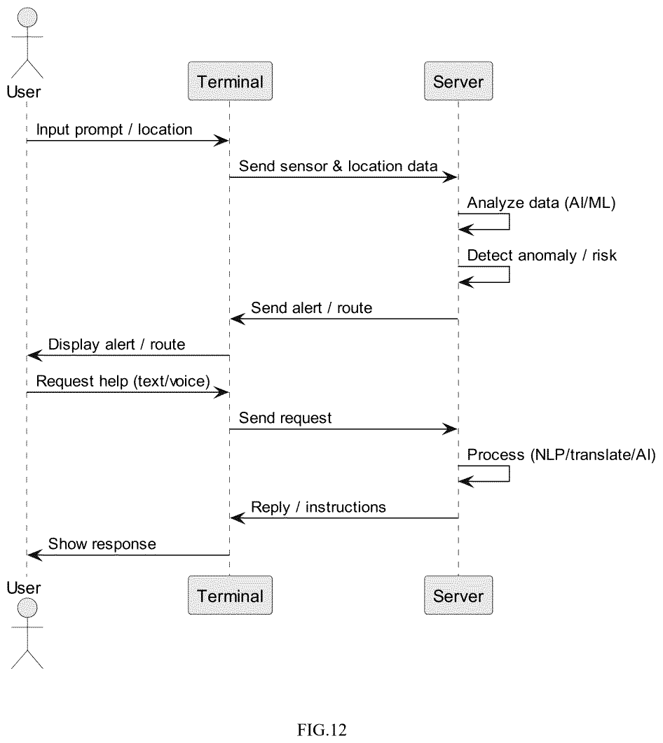

The following describes the processing flow using FIG. 12.

### Step 1:

The server acquires real-time environmental data from measurement devices, such as weather sensors, seismic detectors, and water level meters. The input for this step is raw sensor data streams received via network protocols (e.g., MQTT, HTTP). The server parses, validates, and timestamps each data record, and stores the processed data into a database as output. This ensures that only accurate and properly formatted environmental data are retained for further processing.

### Step 2:

The server performs data cleaning and aggregation on the stored environmental data. The input is the accumulated raw data in the database. The server removes duplicate entries, filters outliers, fills missing values through interpolation, and aggregates statistical metrics (such as mean, max, min, and variance) over predefined time windows. The output is a set of cleaned and aggregated time-series datasets, which are stored in the database for analysis.

### Step 3:

The server analyzes the cleaned environmental data using a machine learning model trained for anomaly detection and disaster precursor identification. The input is the cleaned and aggregated sensor data. The server applies the AI model (e.g., TensorFlow or PyTorch-based model) to detect abnormal fluctuations or patterns indicative of an impending disaster. The output is an anomaly score and, if a threshold is exceeded, a list of detected disaster precursors, which are logged and used for subsequent processes.

### Step 4:

The server retrieves historical disaster data from its storage unit. The input consists of previously archived disaster records, such as past weather events, sensor outputs, and impact reports. The server compares historical data patterns to the current live data and performs risk assessment and future event prediction using time-series analysis and AI-based forecasting. The output is a set of risk scores and predicted disaster likelihoods for specific regions or locations.

### Step 5:

The server generates warning messages when a disaster precursor or elevated risk is detected. The input for this step is the anomaly detection result and risk prediction outcome. The server formats the warning message, specifying disaster type, risk level, affected region, and recommended actions. The output is a structured warning notification ready for transmission.

### Step 6:

The server sends warning notifications to terminals. The input is the prepared warning message. The server uses a cloud messaging service, such as a push notification API, to deliver warnings to user terminals in real time. The output is the transmitted notification, which is received and displayed on user devices.

### Step 7:

The terminal receives the warning notification and informs the user. The input is the warning message sent by the server. The terminal presents the message visually and audibly, using display and sound, and may vibrate to ensure user attention. The output is the successful user alerting.

### Step 8:

The terminal periodically obtains the user's current position using its GPS module. The input here is the device's real-time GPS coordinates. The terminal sends this location data, along with a user identifier and timestamp, to the server for further processing. The output is transmitted location information.

### Step 9:

The server calculates an optimal evacuation route for the user. The input is the user's current location, real-time map data, road closure information, and the location of hazards. The server runs a shortest-path or optimal-route algorithm that avoids dangerous or blocked routes, then generates a step-by-step evacuation guide. The output is the calculated evacuation route tailored to the user's location.

### Step 10:

The server delivers the calculated evacuation route to the terminal. The input is the generated route information. The server transmits this information using a network protocol. The terminal receives and displays the route as a map with detailed instructions. The output is a clear evacuation guide presented to the user.

### Step 11:

The user enters a prompt sentence, such as a rescue request or a query, using voice or text input through the terminal interface. The input is the user's raw audio or text message. The terminal processes the input, converting audio speech into text using speech recognition software, and forwards the processed prompt to the server. The output is a text-based user prompt delivered to the server.

### Step 12:

The server interprets the user's prompt using a natural language processing module and, if necessary, a generative AI model. The input is the text prompt received from the user. The server analyzes the intent, generates an appropriate response, and, if required, translates the message into other languages using a language translation API. The output is an informative answer or a translated message for communication with external organizations.

### Step 13:

The server and terminal implement emotion estimation. The input is text or voice data from the user. The terminal or server runs an algorithm to estimate the emotional state (such as calm, panic, distress), and, based on the detected emotion, the server selects adaptive notification wording or escalates the situation to medical staff or counselors if high-risk emotions are detected. The output is an adapted guidance message or a notification to specialists.

### Step 14:

The server may control autonomous mobile bodies, such as unmanned aerial vehicles or ground robots, to collect site-specific data. The input is the command from the server specifying mission parameters. The server receives image and sensor data from these mobile bodies, analyzes it using computer vision algorithms, and incorporates new findings into ongoing risk assessment and resource allocation planning. The output is enhanced situational awareness and optimized deployment of resources.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Recent years have seen an increase in the frequency and severity of natural disasters, resulting in significant risk to human life, property, and societal infrastructure. Existing disaster management systems are limited in their ability to collect, analyze, and respond to information in real time and often fail to provide optimal evacuation routes, accurate predictions, and effective resource allocation. Furthermore, conventional systems lack the capability to integrate multi-modal data sources, employ advanced artificial intelligence algorithms for early warning and emotional recognition of users, and foster effective multilingual communication between affected areas and support organizations. These deficiencies can cause delays in disaster response, inefficient allocation of resources, and insufficient psychological support for individuals under duress.

The specific processing by the specific processing unit 290 of the data processing device 12 in Example 2 is realized by the following means.

The present invention provides a server including a processor configured to collect and analyze meteorological and physical environment information; predict natural disaster risks; detect abnormal tendencies or fluctuations by machine learning; generate and distribute warning information; calculate optimal evacuation routes based on positional and traffic data; facilitate bidirectional information exchange with language processing and translation; analyze user psychological state; automatically generate prompts for a generative artificial intelligence model; and record and manage disaster-related data. This enables comprehensive and real-time disaster response, including automated early warnings, dynamic evacuation guidance, adaptive resource planning, multilingual communication, and psychological support tailored to individual users, thereby minimizing risks and improving resilience during natural disasters.

The term “meteorological information” refers to data related to atmospheric and weather conditions, including but not limited to temperature, humidity, wind speed, atmospheric pressure, and precipitation.

The term “physical environment information” refers to data obtained from sensors monitoring physical phenomena, such as seismic activity, river water levels, ground movement, and other environmental metrics.

The term “natural disaster risk” refers to the probability or potential severity of damage caused by natural hazards, including events such as earthquakes, floods, typhoons, landslides, and similar calamities.

The term “machine learning algorithm” refers to a computational method that enables a processor to detect patterns, correlations, or anomalies within large data sets by training statistical models using historical data.

The term “precursor sign” refers to a measurable or detectable anomaly or trend that suggests the imminent occurrence of a natural disaster.

The term “warning information” refers to an automatically generated notification or alert, delivered to users or organizations, indicating the potential or onset of a hazardous event.

The term “communication terminal” refers to any user-operated electronic device capable of data communication, including portable information devices, smartphones, tablet computers, and laptop computers.

The term “evacuation route” refers to a calculated path or sequence of directions that allows individuals to move from a potentially hazardous location to a safe area during a disaster.

The term “positioning information” refers to geographical data that represents the present location of a user or device, typically provided as latitude and longitude coordinates. The term “route information processing algorithm” refers to a computational technique for determining optimal or feasible paths through a spatial network based on criteria such as time, distance, and current road or route conditions.

The term “user terminal” refers to an electronic device utilized by an end user for receiving information from or sending information to the server, including but not limited to mobile phones, tablets, and personal computers.

The term “language processing and translation” refers to the analysis and conversion of natural language input to another language by computational means, facilitating comprehension between parties using different languages.

The term “support organization” refers to any entity responsible for providing emergency response, rescue assistance, or relief activities in a disaster scenario.

The term “emotional estimation algorithm” refers to a computational method for analyzing user-provided voice or text data to infer psychological states, such as stress, anxiety, or panic, and classify the emotional condition of a user.

The term “generative artificial intelligence model” refers to a computational model capable of generating natural language text or performing context-based reasoning and dialogue in response to an input prompt, by utilizing advanced pattern recognition and probabilistic inference.

The term “input prompt sentence” refers to a structured textual input designed to elicit an informative, relevant, or actionable response from a generative artificial intelligence model.

The term “autonomous mobile apparatus” refers to a device capable of navigating physical space and collecting data without direct human control, such as an unmanned aerial vehicle or land-based robot equipped with sensing technologies.

The term “image analysis algorithm” refers to a computational method for processing, interpreting, or extracting information from visual data such as photographs, video streams, or sensor-acquired images.

The term “support material” refers to consumable and non-consumable resources required for emergency response, including but not limited to food supplies, water, shelter, medical supplies, and communication devices.

The term “human medical resource” refers to personnel and expertise necessary for providing healthcare services during emergency situations, such as doctors, nurses, and emergency medical technicians.

The term “historical information” refers to previously recorded data and events, especially concerning past natural disasters and their impact, responses, and outcomes.

The term “latest information” refers to the most current data available in the system, including ongoing measurements, observations, and situational updates.

The term “disaster situation” refers to the current or predicted state of emergency conditions resulting from natural hazards, incorporating location, magnitude, affected individuals, and ongoing response measures.

The term “communication content” refers to the information, instructions, or data exchanged between users, the system, and supporting organizations during the operation of the disaster management platform.

One embodiment for practicing the invention involves the implementation of an integrated disaster response system including a server equipped with a processor, at least one communication terminal, and optionally, autonomous mobile apparatus such as unmanned aerial vehicles or ground robots. The following describes the system configuration, utilized hardware and software, and operational examples to enable implementation of the invention as defined in the claims.

The server is equipped with general-purpose computing hardware such as central processing units (CPUs), memory modules, network interfaces, and storage devices. The server executes software components implemented using general-purpose programming languages such as Python. The server is connected via a communication network to a plurality of terminals, various physical sensors, external data sources, and optionally, autonomous devices.

The server collects meteorological information (such as temperature, humidity, precipitation, and wind speed) via application programming interfaces (APIs) provided by meteorological institutions or governmental agencies. The server further collects physical environment information such as seismic data or river water levels, gathered from environmental sensors (for example, seismometers, water level gauges) connected via standard data protocols like TCP/IP or USB.

Collected data is stored and managed in a storage system, typically utilizing a relational database management system (for example, PostgreSQL). The server processes this information using machine learning algorithms, such as anomaly detection models developed using frameworks like TensorFlow. These machine learning algorithms process incoming time-series data streams, detecting abnormal tendencies or precursor signs indicative of natural disaster events.

Upon detection of precursor signs or anomalies that may signify an impending disaster, the server automatically generates warning information. A message creation module selects suitable templates for warnings (for example, earthquake alert, flood warning) and fills in fields regarding the type, location, and estimated time of the event. Warning messages are then transmitted to communication terminals—such as user smartphones, tablets, or personal computers—using standard messaging protocols or APIs (for instance, SMS through Twilio or push notifications).

For evacuation guidance, the terminal (e.g., smartphone) retrieves current location information using its positioning hardware (such as a GPS module) and periodically transmits this data to the server via secure communication channels (for example, HTTPS or WebSocket). The server obtains real-time traffic and road condition information from online mapping services (such as mapping APIs provided by major route information providers) and applies route information processing algorithms (for example, Dijkstra or A*). The server calculates and provides the optimal evacuation route to each user terminal, which then displays the route graphically as an overlay on a digital map application within the terminal.

The server supports bidirectional multilingual information exchange between affected users and support organizations. When a user submits a voice or text report using the terminal application, the server applies natural language processing and translation functions (for example, using cloud-based natural language and translation APIs), automatically analyzing, translating, and forwarding the message as required.

To improve psychological support, the server and terminal analyze the psychological state of users by applying emotion estimation algorithms. The terminal captures user input as speech or text, and analyzes emotional signals (using, for instance, emotion analysis APIs such as a commercial emotion recognition engine). The server evaluates this data and, if necessary, automatically notifies support staff (for example, counselors) or generates suitable instructional or calming content to be delivered to the distressed user.

The server can also operate autonomous mobile apparatus, such as aerial or ground robots, by sending them commands to collect video and sensor data from disaster-affected areas. The apparatus transmit collected data in real time to the server, where image analysis algorithms (such as those implemented using general-purpose image recognition frameworks) are applied to extract relevant situational information.

In resource planning, the server aggregates collected and analyzed data with historical records and constructs structured input prompt sentences. The server transmits these prompts to a generative AI model (for example, a large language model running as a cloud service). The AI model returns analytic predictions and recommendations—such as potential damage extent and prioritized resource allocation—which are then delivered to support organizations.

The server records and manages all generated and received disaster situational data, analyzed results, evacuation routing, warning messages, and communication content in the database for auditing and further learning.

For example, when a river water level sensor detects an abnormal rise during heavy rainfall, the server analyzes the signal using a TensorFlow-based model and generates a warning notification which is sent to nearby users and emergency authorities. In the event of an earthquake, the server directs a mobile robot equipped with image recognition capability to survey damaged sites and reports findings in real time to rescue teams.

Examples of prompt sentences supplied to the generative AI model include:

“Please describe the analysis procedure to be taken when water-level sensors detect an anomaly under continued heavy rainfall.”

“Describe the procedure for generating and sending a warning message to relevant agencies when the system detects an anomaly in seismometer data.”

“Explain the steps for calculating an optimal evacuation route using GPS data and real-time traffic information.”

“Describe the process for analyzing a user's emotional state during a disaster and providing an appropriate response.”

Through integration of advanced hardware and software components, including real-time sensor networks, cloud-based artificial intelligence infrastructure, advanced routing algorithms, natural language processing, and autonomous mobile apparatus, the present invention enables a comprehensive, real-time, and adaptive disaster response platform in line with the claims.

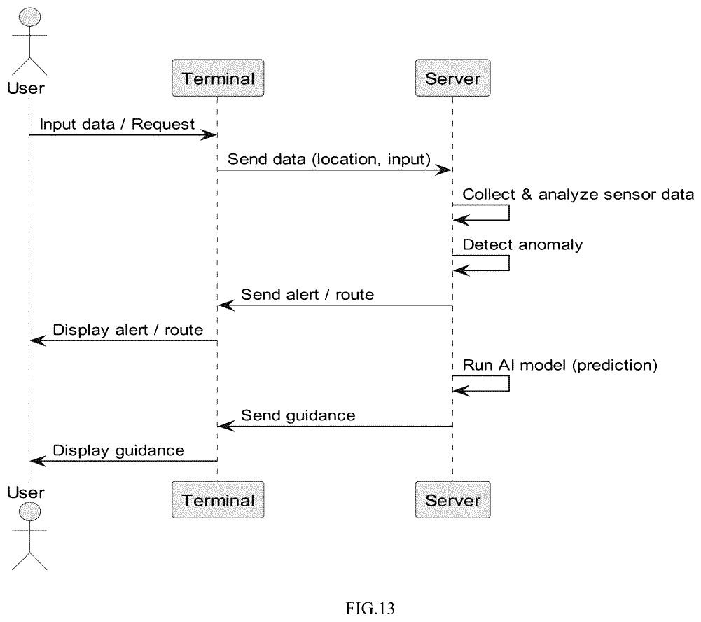

The following describes the processing flow using FIG. 13.

### Step 1:

The server collects meteorological information and physical environment information by periodically sending API requests to external data sources and directly receiving data from various environmental sensors.

Input: Real-time data streams from meteorological service APIs and physical sensors (such as seismometers and water level gauges).

Processing: The server parses, validates, and timestamps the incoming data.

Output: Structured, time-stamped data entries are generated and prepared for storage.

### Step 2:

The server stores the structured data entries in a relational database, ensuring all records are indexed and can be efficiently retrieved for later analysis.

Input: Parsed and validated meteorological and sensor data.

Processing: The server writes the data into the database management system, organizing records by type, source, and timestamp.

Output: A continuously updated, indexed data repository.

### Step 3:

The server retrieves recent data entries and performs anomaly detection using machine learning algorithms (for example, TensorFlow models).

Input: Stored meteorological and sensor data from the database.

Processing: The server applies an anomaly detection model to time-series datasets, calculating scores or flags that indicate unusual trends or precursor signs.

Output: Anomaly detection results, including identified precursors and associated data.

### Step 4:

The server generates warning information when a precursor sign is identified and transmits warnings to user terminals and relevant organizations.

Input: Anomaly detection results with flagged precursors.

Processing: The server selects a warning message template, populates event-specific details, and sends alerts using messaging APIs (such as SMS or push notifications).

Output: Delivered warning notifications and records of sent alerts.

### Step 5:

The terminal periodically obtains the location of a user via a positioning module, formats the positional data, and transmits it to the server.

Input: Real-time GPS or positioning data.

Processing: The terminal formats and securely sends the current location to the server at designated intervals.

Output: Location data received by the server.

### Step 6:

The server acquires real-time traffic and road information by querying online mapping service APIs.

Input: User location and mapping service API requests.

Processing: The server processes real-time mapping responses and extracts up-to-date information on roads, congestion, and hazards.

Output: Refined traffic and environmental data for evacuation computation.

### Step 7:

The server calculates optimal evacuation routes using received user locations and updated traffic data, employing route optimization algorithms such as Dijkstra or A*.

Input: User location data and real-time traffic information.

Processing: The server constructs a route network, applies the chosen algorithm, and determines the best available evacuation route.

Output: Computed evacuation route and navigation instructions.

### Step 8:

The server sends the computed evacuation route details to the terminal, which then visually displays the route via a mapping application.

Input: Calculated evacuation route from the server.

Processing: The terminal overlays the route onto a digital map, provides instructions, and notifies the user.

Output: A visual and textual representation of the evacuation route to the user.

### Step 9:

The user submits voice or text input to request assistance or provide situation updates via the terminal application.

Input: User's voice recording or text message.

Processing: The terminal captures and transmits the input data to the server.

Output: User input data delivered to the server.

### Step 10:

The server applies natural language processing and, if necessary, translation algorithms to the received user input for communication with support organizations.

Input: Voice or text input from users.

Processing: The server transcribes, analyzes, and translates the input using language processing APIs and translation engines.

Output: Actionable, possibly translated, information sent to relevant support organizations.

### Step 11:

The server aggregates current and historical data, creates a structured prompt sentence, and supplies it to a generative AI model to produce disaster predictions and resource recommendations.

Input: Historical records, current sensor or weather data.

Processing: The server constructs a prompt, communicates with the generative AI model, and interprets the AI's output.

Output: Predicted disaster impact, resource allocation plans, and emergency strategies.

### Step 12:

The server controls autonomous mobile apparatus to collect situational data from disaster areas, then processes the incoming video or sensor data for actionable insights.

Input: Commands to autonomous devices; audio, visual, and sensor data from disaster sites.

Processing: The server directs the device, receives real-time data streams, and analyzes images or sensor readings with image analysis algorithms.

Output: Real-time situation assessments sent to rescue teams or support organizations.

### Step 13:

The terminal and server analyze the emotional state of the user based on submitted voice or text input, using emotion estimation algorithms to assess psychological needs.

Input: User speech, text, or facial expression data.

Processing: The terminal or server applies an emotion classification model and interprets the results.

Output: Emotional assessment, notifications to support staff if needed, and tailored guidance or alert messages delivered to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional disaster management systems face significant limitations in rapidly and accurately detecting abnormal environmental or physical changes, providing context-aware evacuation guidance, and efficiently responding to the emotional state of affected individuals in real time. Existing systems often lack the ability to integrate real-time sensor data, utilize advanced artificial intelligence for anomaly detection and risk prediction, and adaptively support both human users and autonomous vehicles through dynamic information exchange and emotional response functionalities. As a result, there is a need for a comprehensive disaster response system that can optimize evacuation, resource allocation, on-site data collection, and emotional support by leveraging advanced data processing, machine learning, and generative artificial intelligence models.

The specific processing by the specific processing unit 290 of the data processing device 12 in Application Example 2 is realized by the following means.

The present invention provides a server including a processor configured to automatically collect time-series environmental and physical quantity data, analyze said data using machine learning algorithms to detect anomalies and predict risks, transmit alert and evacuation information to terminal devices, calculate optimal evacuation routes based on real-time conditions, generate responsive information by inputting prompts to a generative artificial intelligence model, and interpret emotional states to offer personalized support messages and resource optimization functions. This enables comprehensive, adaptive disaster management by integrating data-driven decision-making, real-time environmental monitoring, user-specific emotional response, and autonomous system coordination, thereby significantly improving safety, efficiency, and user experience in emergency situations.

The term “environmental data” refers to information collected from observation devices related to meteorological, atmospheric, hydrological, or other surrounding physical conditions, including but not limited to temperature, rainfall, humidity, or wind speed.

The term “physical quantity data” refers to numerical or measurable data obtained from measurement devices regarding physical parameters such as vibration, acceleration, water level, seismic intensity, or pressure.

The term “observation device” refers to a hardware apparatus used to monitor and acquire environmental data, which may include weather stations, remote sensors, satellites, or automated monitoring terminals.

The term “measurement device” refers to an instrument or sensor that quantifies and records specific physical quantities, such as seismometers, water level gauges, or accelerometers.

The term “time-series data” refers to data points collected and recorded at sequential time intervals, enabling trend and anomaly analysis over a specified period.

The term “storage device” refers to any memory component or data repository, including on-premise or cloud-based databases, that retains collected data for subsequent processing and analysis.

The term “machine learning algorithm” refers to a computational method that processes data and learns patterns or relationships, including but not limited to supervised, unsupervised, or deep learning models.

The term “anomalous variation” refers to a significant deviation, detected by analysis, from normal or expected data patterns, which may indicate an abnormal or hazardous event.

The term “risk event” refers to a predicted or potential occurrence of a hazardous situation, calculated based on detected anomalies or data trends.

The term “action terminal device” refers to a user-operated or automated endpoint, such as a mobile terminal, tablet, computer, or in-vehicle system, that receives, displays, or responds to disaster-related information.

The term “route search algorithm” refers to a computational method for calculating optimal travel or evacuation paths based on location, traffic, and environmental data.

The term “emotion recognition algorithm” refers to a software method capable of analyzing user input (voice, text, or sensor information) to identify and interpret the user's emotional state.

The term “generative artificial intelligence model” refers to a machine learning model capable of producing text, responses, recommendations, or other data outputs based on input prompts, including language models or similar generative systems.

The term “prompt sentence” refers to an input statement, question, or request presented to a generative artificial intelligence model in order to elicit a specific output or response.

The term “support team” refers to a group or organization tasked with providing rescue, relief, medical care, or logistical support during or after a disaster event.

The term “autonomous moving device” refers to an unmanned vehicle, such as a drone or robot, capable of operating independently for the purposes of data collection or site exploration.

The term “remotely operated device” refers to a machine or tool controlled by a user from a distance, which may include drones, robots, or automated vehicles for on-site operations.

The term “bidirectional communication” refers to the mutual exchange of information between two or more parties, enabling the sharing of data, messages, or commands in both directions.

One embodiment of the present invention is a disaster management system including a server, at least one terminal device, a set of observation and measurement devices, and one or more support teams connected via a communication network.

The server includes a processor and storage device. The processor is implemented as a general-purpose computing device or a cloud-based instance capable of executing machine learning and data processing tasks. The server is configured to automatically collect environmental data (such as meteorological and atmospheric information) from observation devices, and physical quantity data (including, for example, water level, seismic data, or vibration data) from measurement devices. Examples of suitable observation and measurement devices include weather stations, seismometers, river water level gauges, and atmospheric sensors.

The server stores the time-series data received from these devices using a scalable database technology such as a relational database (e.g., PostgreSQL or MySQL) or a cloud storage solution. The server is further configured to preprocess the collected data by normalizing, validating, and timestamping each data record.

The server implements a machine learning algorithm, preferably using a deep learning framework such as TensorFlow or PyTorch, which is trained on historical disaster and environmental data. The machine learning model is used to detect anomalous variations and predict potential risk events (such as floods or earthquakes) in real time. When such anomalies or risk events are detected, the server automatically generates and transmits alert information to designated action terminal devices (such as smartphones, tablets, vehicle-mounted displays, or computer terminals) via network protocols (e.g., HTTP, MQTT, or push notification services).

Each terminal is implemented as a mobile or stationary computing device equipped with hardware for position acquisition, such as GPS modules for smartphones or GNSS receivers for vehicles. The terminal obtains the user's or device's current location and transmits this position data securely to the server. The terminal further receives alert or evacuation messages and displays such messages with visual, auditory, or tactile notifications.

For evacuation support, the server uses a route search algorithm, such as a Dijkstra or A* pathfinding algorithm, in conjunction with third-party APIs for real-time traffic and road information. The server calculates the optimal evacuation route based on the user's location, current road conditions, and hazard status, and communicates the computed route to the terminal device, which renders the route and provides turn-by-turn guidance using mapping software such as Mapbox GL or the terminal's native mapping application.

The terminal is also equipped with a software component or application for collecting user input, such as voice recordings or text entered via touch interface. The terminal or server analyzes this input using an emotion recognition algorithm implemented with available natural language processing or speech analysis technologies (for example, using BERT, Google ML Kit, or similar tools) to determine the emotional state of the user. If the user is identified as being in a high-stress or panic state, the server can respond by generating a customized supportive message.

The supportive and response messages are generated by prompting a generative artificial intelligence model, such as a large-language model (for example, GPT-based or similar generative models), with an appropriate prompt sentence. The prompt sentence is constructed by the server or terminal in accordance with the detected context and user state.

The server also enables communication and information exchange with the support team in the affected area, including sharing real-time sensor data, user locations, route status, damage predictions, and collected on-site images or video. The server is further capable of controlling autonomous moving devices (such as drones or robots) and remotely operated devices to collect imagery and environmental data from disaster scenes, using standard industrial communication protocols (e.g., MAVLink).

Additionally, the system is equipped to generate disaster response support information or automatic responses by inputting prompt sentences to the generative artificial intelligence model. For example, in response to user or operator input, the system may generate evacuation advice, resource allocation recommendations, or reassuring messages based on generated outputs.

Example prompt sentences that may be used with the generative AI model include the following:
“Please calculate the best evacuation route from my current location to the nearest safe shelter.”
“Generate a forecast of the expected damage and required relief supplies for an incoming typhoon.”
“Send a comforting message to users exhibiting panic during an evacuation.”
“Provide an overview of current disaster risk based on the latest sensor and meteorological data.”
“Summarize key findings from real-time drone footage for emergency responders.”

Through the described configuration, the invention enables a highly responsive and adaptive disaster management solution, integrating automated data collection, advanced machine learning, generative AI processing, real-time route optimization, multi-channel alerting, emotional support, and coordinated communications among all involved entities.

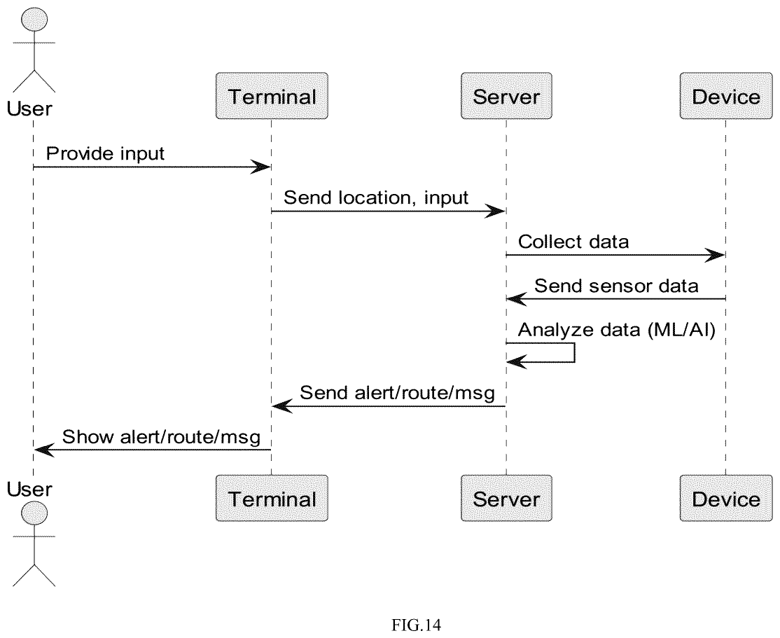

The following describes the processing flow using FIG. 14.

### Step 1:

Server receives environmental data from observation devices and physical quantity data from measurement devices in real time. The input is a stream of raw sensor data, which the server validates and timestamps before storing it in a database. The output is structured, time-series data records held in persistent storage.

### Step 2:

Server loads the stored time-series data and applies preprocessing, such as normalization and anomaly filtering. The input is the validated time-series dataset. The server then applies a machine learning algorithm to detect any anomalous variations or patterns within the data. The output is a set of detected anomalies or alerts indicating unusual events and potential risks.

### Step 3:

Server inputs the anomaly detection results and current environmental context into a risk assessment module powered by machine learning. The input is anomaly data and additional real-time sensor or external data. The server calculates the risk level of disaster events (for example, a flood or earthquake). The output is a quantified risk profile and a set of triggered alert messages.

### Step 4:

Server transmits relevant alert and warning messages to the appropriate terminal devices via a push notification service. The input is the triggered alert message including location and type of event. The terminal receives, displays, and notifies the user of the alert using sound, vibration, and on-screen notifications. The output is the successful presentation of emergency warnings on the terminal.

### Step 5:

Terminal obtains the user's current position using GPS hardware and transmits this information to the server. The input is raw GPS coordinate data. The terminal may also supplement the location data with device ID and time. The output is the user's current position report sent to the server.

### Step 6:

Server receives the position data and collects up-to-date road and traffic conditions from external APIs. The server uses a route search algorithm to calculate the safest evacuation route, taking into account possible obstructions or hazards detected in previous steps. The input is user location, road, and hazard data. The output is a safe and optimized evacuation route packaged in a suitable format, such as GeoJSON, for return to the terminal.

### Step 7:

Terminal receives the calculated evacuation route and overlays the route map in the user interface. The input is the route data from the server. The terminal provides turn-by-turn navigation and may use text-to-speech software for voice guidance. The output is a real-time display and verbal instructions of the evacuation path for the user.

### Step 8:

Terminal receives user voice input or text entry regarding their current emotional state or situation. The input is captured audio or written responses. The terminal, or alternatively the server, uses an emotion recognition algorithm to analyze the input. The output is an emotion recognition result, which identifies if the user is in distress, panic, or other notable states.

### Step 9:

Server receives the emotion recognition result from the terminal. If a high-stress or panic state is detected, the server prepares a prompt sentence (e.g., “Send a comforting message to users exhibiting panic during an evacuation.”) and sends it to a generative AI model. The input is the detected emotional status and the constructed prompt. The server receives and logs the AI-generated supportive message as output.

### Step 10:

Server transmits the AI-generated supportive or instructive message to the terminal for display to the user. The input is the message generated by the AI model. The output is the presentation of context-aware, personalized support content on the user's device, such as text and/or voice reassurance.

### Step 11:

Server controls autonomous moving devices or remotely operated devices to collect on-site images and environmental data from affected areas. The input is device control instructions and mission parameters. The devices perform data acquisition and transmit results back to the server. The output is real-time images and sensor readings, which are then incorporated into further route calculation and risk assessment.

### Step 12:

Server enables bidirectional communication with support teams by sharing relevant data, such as live risk assessments, user locations, collected imagery, and resource allocation status. The input is accumulated data and analytical results. The output is comprehensive, up-to-date situational awareness for support team members, delivered via dashboard, messaging, or other coordination channels.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

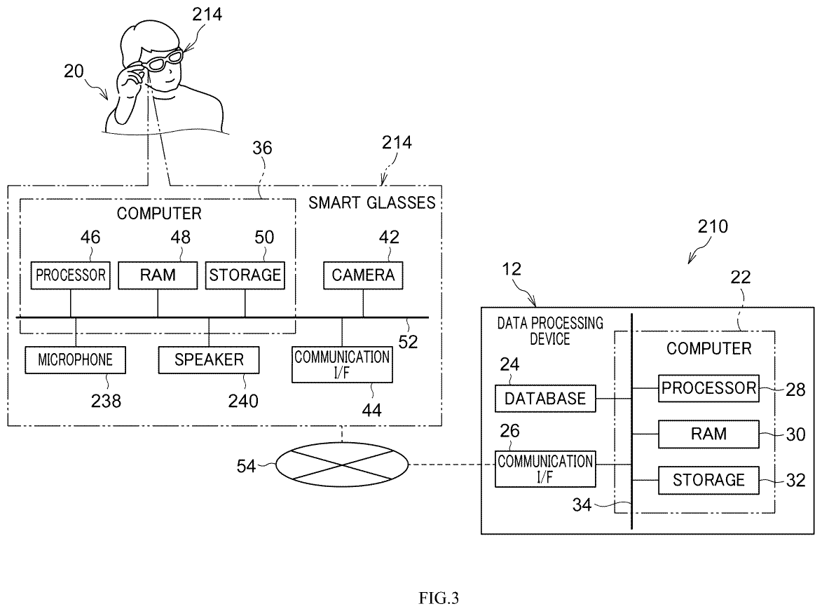

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

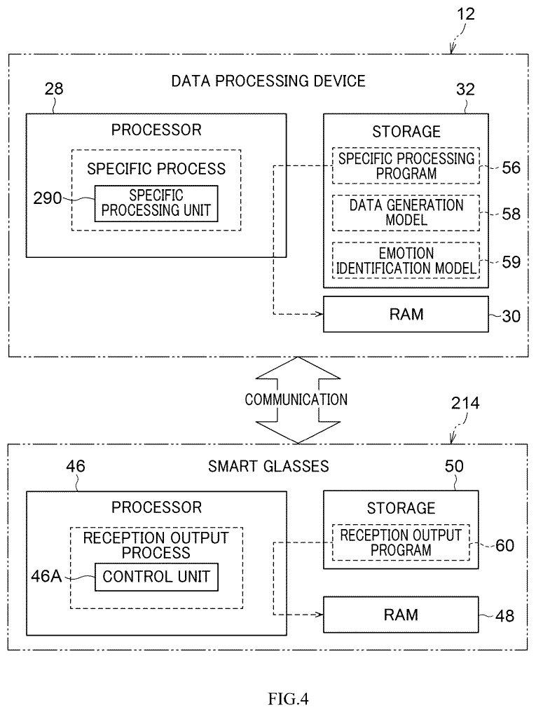

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

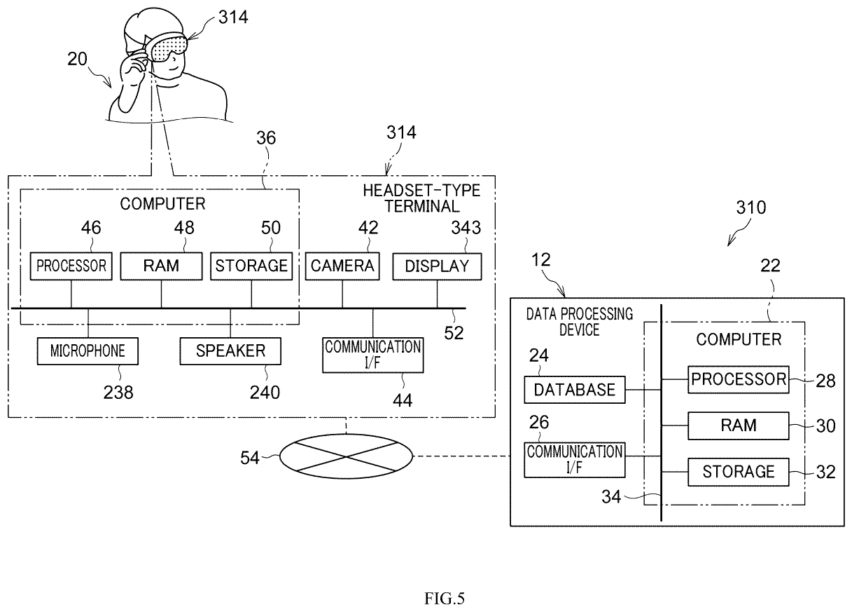

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

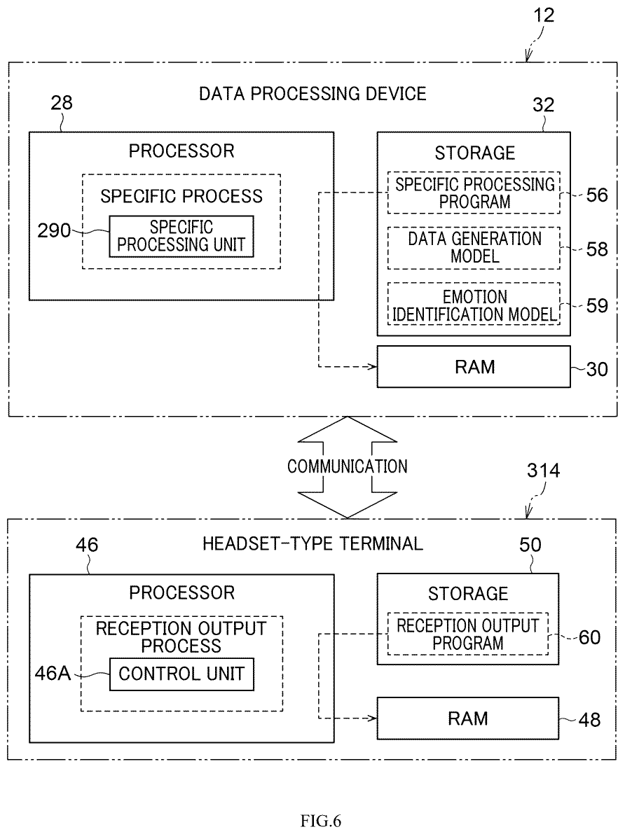

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

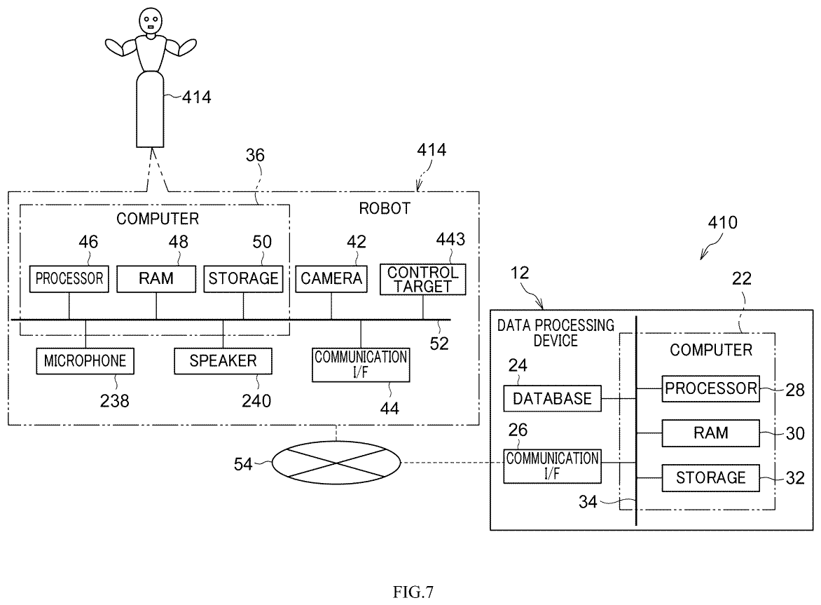

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

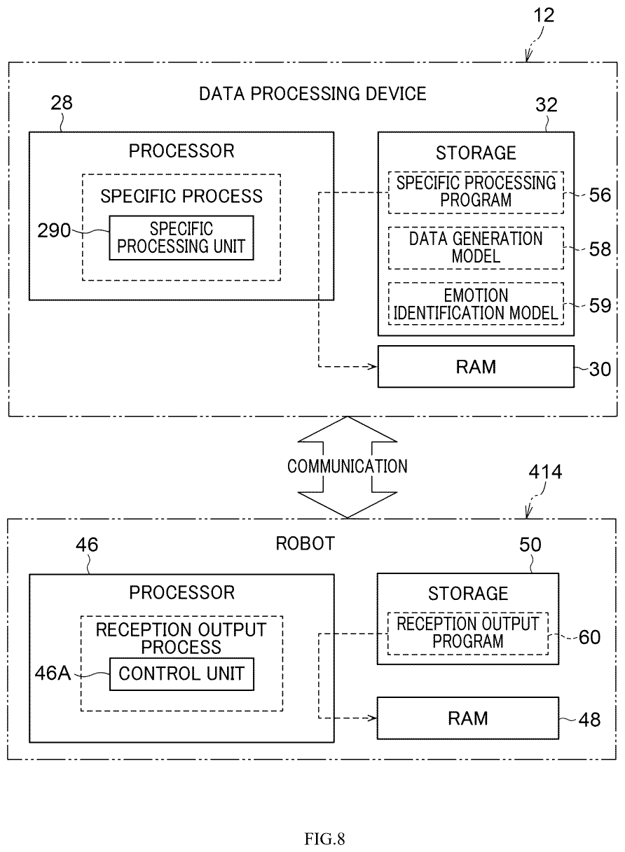

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

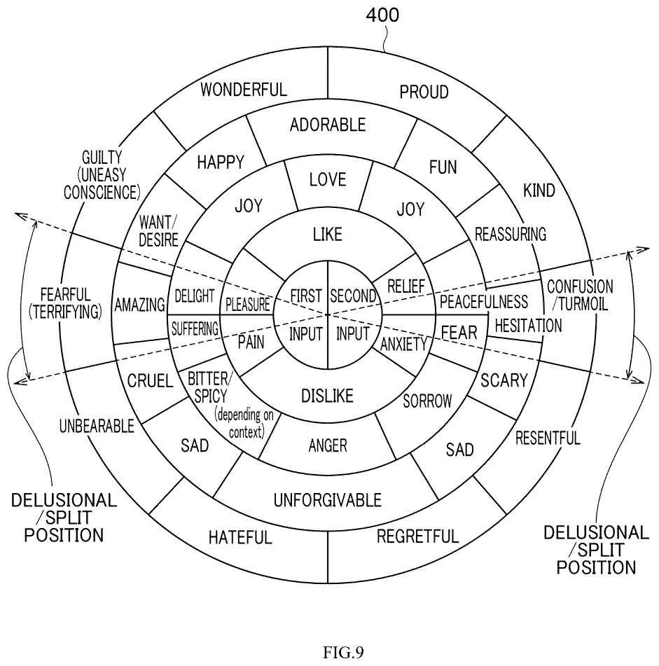

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

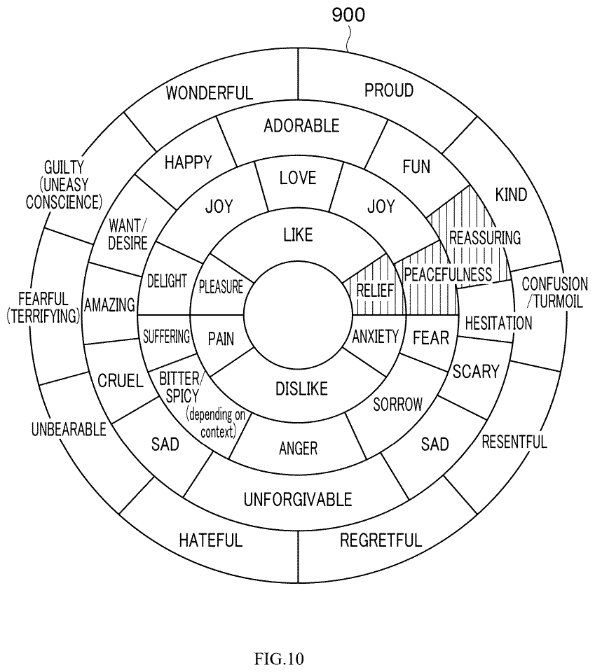

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
collect and standardize time-series environmental data and status data obtained from observation devices,
analyze the environmental data and status data using a machine learning model to automatically detect abnormal trends,
analyze past disaster-related data by inputting prompt sentences to a generative artificial intelligence model to predict future risks,
upon recognition of hazard indications based on analysis results, immediately notify alert information to user devices via a communication unit,
calculate an optimal evacuation route by considering current situational data, movement information, and traffic conditions using a route generation unit, and provide guidance information to user devices, and
analyze input information coming through the user devices to coordinate information delivery and support request processing between organizations engaged in relief activities.

### (Supplementary 2)

The system according to supplementary 1,
wherein the processor is configured to control an autonomous mobile body via a control unit for the autonomous mobile body, and acquire and analyze real-time image information or environmental data of a site by applying artificial intelligence to the autonomous mobile body.

### (Supplementary 3)

The system according to supplementary 1,
wherein the processor is configured to estimate areas of impact and disaster risk based on the collected and analyzed data, and to develop allocation plans for necessary life support supplies and medical resources.

### Application Example 1

### (Supplementary 1)

A system including a processor,
wherein the processor is configured to
acquire time-series data in real time from a group of measurement devices and store the data in a storage unit, and perform anomaly detection and extraction of disaster precursors by an analysis unit,
obtain historical record data related to environmental disasters from a historical data storage unit and perform future event prediction and disaster risk estimation by executing prediction operations in an analysis unit,
input multiple types of sensor information and historical information into a high-level feature extraction unit, and determine the presence of abnormal fluctuations and disaster precursors using a machine learning unit,
automatically generate and distribute warning information to notification devices or portable information terminals when an anomaly or disaster precursor is detected,
acquire positional information from a positioning device, integrate dynamic route network information and traffic obstruction information, calculate evacuation guidance information, and present it in real time to portable information terminals,
analyze audio or text input, interpret the content using an audio processing unit and natural language processing unit, translate the interpreted content with a multilingual conversion unit, and share the translated information via an external communication network with relevant organizations,
estimate a user's emotional state by an emotion evaluation unit based on audio or text information, and control the warning content or notification method adaptively according to the emotional information,
provide a response generation unit that automatically generates appropriate answers or evacuation instructions using a generative artificial intelligence model in response to questions or prompt sentences received from a user.

### (Supplementary 2)

The system according to supplementary 1,
wherein the processor is configured to remotely control an autonomous mobile body, receive image and measurement data obtained by observation devices and imaging devices in real time, and have an analysis unit perform on-site situation analysis and extraction of specific information.

### (Supplementary 3)

The system according to supplementary 1,
wherein the processor is configured to integrate time-series information and environmental data by the analysis unit, estimate an affected area by an influence area prediction unit, and generate an optimal resource allocation plan for materials and personnel using a resource allocation planning unit.

### Example 2

### (Supplementary 1)

A system including a processor,
wherein the processor is configured to
collect and analyze meteorological information and physical environment information in a time series manner,
predict future natural disaster risk based on information regarding past natural disasters,
use a machine learning algorithm to detect abnormal tendencies or fluctuations within information sets and identify precursor signs,
automatically generate warning information based on the detected precursor signs and deliver the warning information to communication terminals,
calculate optimal evacuation routes using positioning information and route information processing algorithms, and provide such routes to user terminals,
perform language processing and translation on voice or text received from user terminals or the processor and enable bidirectional information exchange between disaster-affected areas and support organizations,
analyze the psychological state of users by estimating emotions from acquired voice or text information using an emotion estimation algorithm, and generate instructions or alerts based on the psychological state,
automatically generate input prompt sentences for a generative artificial intelligence model by combining historical information and latest information, and perform dialogue-based analysis and response generation via the generative artificial intelligence model, and
record and manage inferred disaster situations, evacuation routes, predictions, and communication content by the system.

### (Supplementary 2)

The system according to supplementary 1,
wherein the processor is configured to operate an autonomous mobile apparatus equipped with artificial intelligence functionality, collect video information and measured data from a disaster-affected site, transmit the data to the processor, and analyze the data using an image analysis algorithm or the like.

### (Supplementary 3)

The system according to supplementary 1,
wherein the processor is configured to predict the extent and risk of damage, and allocate required support materials and human medical resources in a planned manner to relevant organizations, based on the information collected and analyzed and output from the generative artificial intelligence model.

### Application Example 2

### (Supplementary 1)

A system including a processor,
wherein the processor is configured to
automatically collect time-series environmental data from an observation device and physical quantity data from a measurement device, and store said data in a storage device;
input the stored time-series data into a machine learning algorithm to detect anomalous variations and predict future risk events;
automatically transmit alert information to an action terminal device based on said anomalous variations and the predicted risk events;
calculate a secure travel route based on location information of the terminal device, traffic information, and road information by using a route search algorithm, and display the calculated route on the terminal device;
interpret an emotional state of a user of the terminal device by using an emotion recognition algorithm, and automatically generate evacuation support information or a reassuring message corresponding to said emotional state;
generate disaster response support information or automatic responses by inputting a prompt sentence to a generative artificial intelligence model; and
support bidirectional communication of information with a support team in the affected area.

### (Supplementary 2)

The system according to supplementary 1,
wherein the processor is configured to
control an autonomous moving device or a remotely operated device to collect, in real time, image information regarding the on-site situation and data regarding the surrounding environment, and analyze the collected information.

### (Supplementary 3)

The system according to supplementary 1,
wherein the processor is configured to
estimate damage areas and problem occurrence areas based on the accumulated data and analysis results, and optimally allocate necessary materials and medical support resources.

What is claimed is:

1. A system comprising a processor,
wherein the processor is configured to
collect and analyze meteorological data and sensor data in real time,
predict future disaster risks based on past disaster data,
detect abnormal patterns and identify precursors of disasters,
automatically issue warnings based on identified precursors,
calculate optimal evacuation routes and provide them to users in real time, and
support information exchange between affected areas and relief teams.

2. The system according to claim 1, wherein the processor is configured to control AI-equipped drones and robots to collect and analyze information from disaster sites in real time.

3. The system according to claim 1, wherein the processor is configured to predict the extent of damage and risk based on collected and analyzed data and plan the allocation of necessary relief supplies and medical resources.

4. The system according to claim 1, wherein the processor is configured to perform natural language processing and translation between different languages to enhance communication between affected areas and relief teams.
